(19) United States
(12) Patent Application Publication
(10) Pub. No.: US 2019/0289693 A1
(43) Pub. Date: Sep. 19, 2019

(54) AUTOMATIC HANDLING OF LAMP LOAD ON DO CHANNEL

(71) Applicant: Honeywell International Inc., Morris Plains, NJ (US)

(72) Inventors: Ram Mohan Anugu, Bangalore (IN); Nagaraja Sundaresh, Hyderabad (IN); Vivek Vijayakumar, Hyderabad (IN); Shripad Kumar Pande, Hyderbad (IN)

(21) Appl. No.: 15/921,562

(22) Filed: Mar. 14, 2018

(51) Int. Cl. H05B 37/02; G05B 19/05

(52) U.S. Cl. CPC H05B 37/0227; G05B 2219/1134; G05B 19/054

(57) ABSTRACT

A digital output module, method, and non-transitory computer readable medium provide for automatic handling of a lamp load on a digital output channel. The digital output module includes a digital output control switch and a processor operably connected to the digital output control switch. The digital output control switch opens and closes a circuit to a lamp load. The processor receives a readback of a current value applied to the lamp load attached to the digital output module, and controls the digital output control switch based on the readback current value.

### TECHNICAL FIELD

This disclosure relates generally to programmable logic controllers (PLC). More specifically, this disclosure relates to methods and systems to automatic handling of a lamp load on a digital output (DO) channel on a PLC controller in an industrial control system.

### BACKGROUND

Digital output modules are used to turn on different types of loads in an industrial control system. Lamp load is a common type of load connected to a digital output channel on a PLC or controller in an industrial control system. Among the load types, a lamp load has a distinct characteristic of drawing a high current during turn ON, which makes it hard to handle using a digital output module.

Lamp load significantly poses challenge to the hardware design of the digital output module due to the extremely high inrush current during the turning ON of the lamp. Lamp load switch-on current of a filament lamp is many times greater than the rated current since the cold resistance is much lower than the resistance when the lamp is glowing.

### SUMMARY

This disclosure provides for automatic handling of a lamp load on a digital output channel.

In a first embodiment, a digital output module including a digital output control switch and a processor operably connected to the digital output control switch is provided. The digital output control switch opens and closes a circuit to a lamp load. The processor receive a readback of a current value applied to the lamp load attached to the digital output module; and control the digital output control switch based on the readback current value.

In a second embodiment, a method for a digital output module is provided. The method includes receiving a readback of a current value applied to a lamp load attached to the digital output module; and controlling the digital output control switch based on the readback current value, wherein the digital output control switch opens and closes a circuit to the lamp load.

In a third embodiment, a non-transitory computer readable medium is provided. The computer readable medium machine-readable medium is encoded with executable instructions that, when executed, cause one or more processors to receive a readback of a current value applied to a lamp load attached to the digital output module; and control the digital output control switch based on the readback current value, wherein the digital output control switch opens and closes a circuit to the lamp load.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial control and automation system according to this disclosure;

FIG. 2 illustrates additional details of a portion of an example industrial process and automation system according to this disclosure;

FIG. 3 illustrates a block diagram for a hardware scheme for a digital output module with enhanced support for lamp load according to this disclosure;

FIG. 4 illustrates a lamp load algorithm for one channel according to this disclosure;

FIG. 5 illustrates multiple lamp loads handling according to this disclosure; and

FIG. 6 illustrates an example process for automatic handling of lamp load on a digital output channel according to this disclosure.

### DETAILED DESCRIPTION

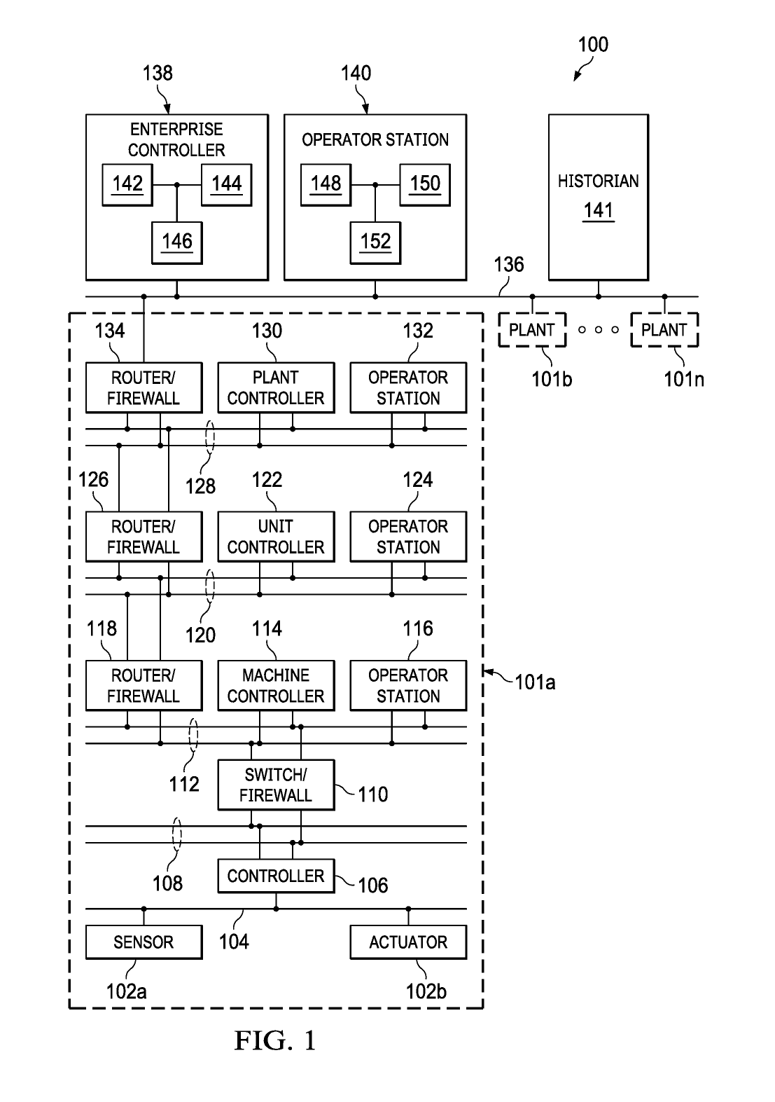

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any type of suitably arranged device or system.

This disclosure presents a method to reduce the inrush current requirements for the lamp load by using software control. Reducing the inrush current requirements brings down the hardware complexity since a higher wattage lamp can be supported with lower inrush current support on hardware. Lowering inrush current support can be advantageous since digital output channels can support higher wattage lamp load with lower inrush current requirements.

In some conventional systems, a user creates a special configuration logic in the PLC/controller for handling lamp loads. Such configurations prevent turning ON of all lamp loads simultaneously thereby maintaining the current below the inrush current specification of the module. However, this increases the burden on the engineering and makes the solution complex to manage and debug. Other systems use a relay-based approach for driving the lamp from an external supply. However, this requires additional hardware and space in the cabinet. In addition, the characteristics of the lamp load restrict the maximum number of lamps that can be supported and also restrict the wattage of the lamps supported.

To address these and other issues, the disclosed embodiments provide a solution that brings down the inrush current requirement, allows support for higher wattage lamp load, and allows connecting more lamp loads to a single digital output module.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, flow rate, or a voltage transmitted through a cable. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS (FF) network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

In accordance with this disclosure, various components of the system 100 support a process for automatic handling of a lamp load on a digital output channel according to this disclosure in the system 100. For example, one or more of the controller 106, one or more processing devices 1422, and one or more processing device 148 could indicate to an output control module or digital output that a lamp needs activating for one or more reasons, as described in greater detail below.

Although FIG. 1 illustrates one example of an industrial process control and automation system 100, various changes may be made to FIG. 1. For example, a control system could include any number of sensors, actuators, controllers, servers, operator stations, and networks. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs.

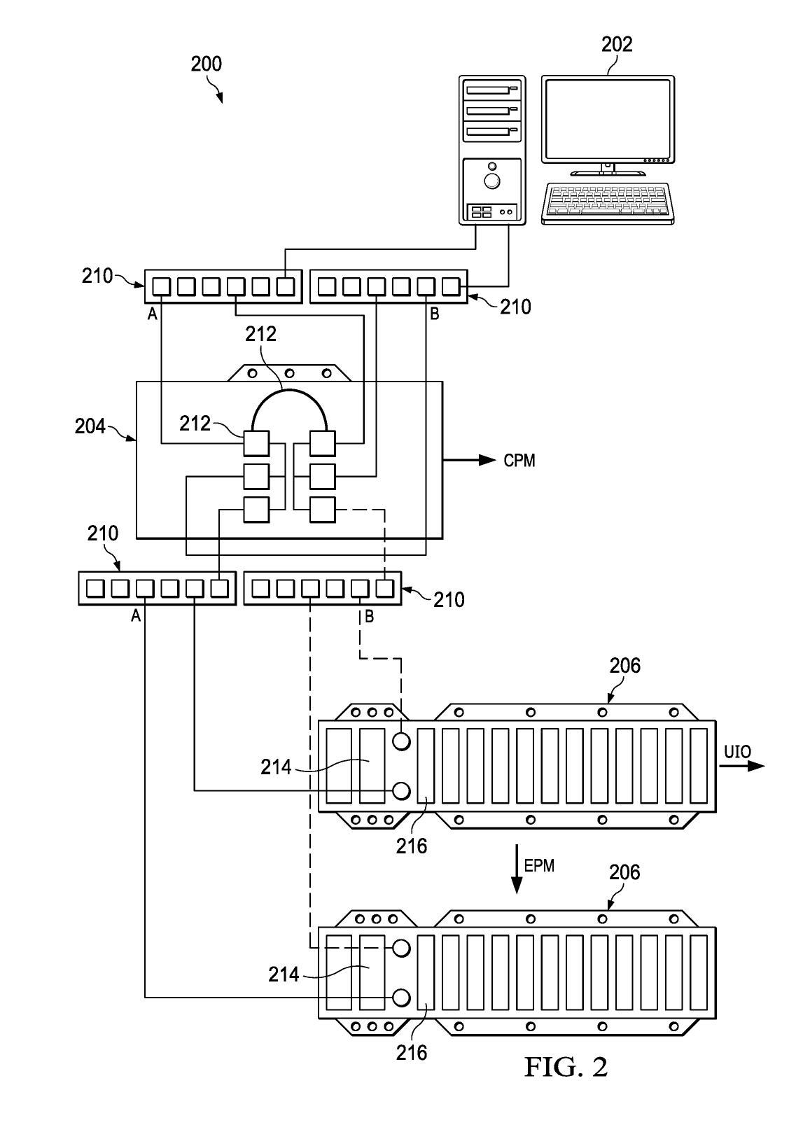

FIG. 2 illustrates additional details of a portion of an example industrial process and automation system 200 according to this disclosure. Many of the components shown in FIG. 2 may represent or be represented by corresponding components of the system 100 of FIG. 1. However, the system 200 could be used as part of any other suitable system.

As shown in FIG. 2, the system 200 includes various portions of a programmable logic controller (PLC) system. The components include one or more operator stations 202, a control processor module (CPM) rack 204, multiple expansion I/O racks 206, and multiple switches or routers 210. In some embodiments, the system 200 represents portions of a ControlEdge system by HONEYWELL INTERNATIONAL INC.

Each operator station 202 could be used to provide information to and receive information from an operator. For example, the operator station 202 could operate in a manner similar to one or more of the operator stations 140 of FIG. 1. As particular examples, each operator station 202 could provide information identifying a current state of an industrial process to an operator and receive information affecting how the industrial process is controlled. Each operator station 202 includes any suitable structure for displaying information to and interacting with an operator.

The racks 204-206 represent electronic component racks or cabinets having shelves and slots or other structures for installation of electronic components. In this example, the CPM rack 204 includes one or more CPMs 212. Each expansion I/O rack 206 includes an expansion processor module (EPM) 214. Depending on the configuration, each rack 204-206 includes zero, one, or multiple I/O modules 216. In this example, the CPM rack 204 does not include any I/O modules 216, and the expansion I/O racks 206 include multiple I/O modules 216. Common rack installations may include four, eight, or twelve I/O modules 216, although other numbers of I/O modules 216 are possible. Each rack 204-206 can also include one or more power supplies (not shown) for providing power to the rack 204-206 or to the components installed in the rack 204-206.

The CPMs 212 and EPMs 214 are PLC controllers and may represent or be represented by the controllers 106 of FIG. 1. The CPMs 212 and EPMs 214 perform various functions for control of one or more industrial processes. For example, the CPMs 212 or EPMs 214 may use measurements from one or more sensors (such as the sensors 102a) to control the operation of one or more actuators (such as the actuators 102b). These CPMs 212 and EPMs 214 could interact with the sensors, actuators, and other field devices via the I/O modules 216.

The CPMs 212 are considered “local” controllers and represent initial controllers installed for operation of a process control and automation system. In the “local” CPM rack 204, one of the CPMs 212 can be considered a primary controller, while the other CPM 212 can be considered a secondary controller, back-up controller, or redundancy controller. If a process control and automation system is large and requires expansion beyond the capacity of the local CPMs 212, one or more EPMs 214 can be installed and configured in the expansion I/O racks 206 to provide expanded capability in the process control and automation system, such as shown in the system 200. The CPMs 212 and EPMs 214 are configured to form a network, such as an Ethernet network. In such a network, at least one of the CPMs 212 acts as a “central” controller that provides instruction messages to the “expanded controllers” represented by the EPMs 214. Various EPMs 214 can be included in the system 200 or removed from the system 200 by plugging or unplugging cables at the EPMs 214. Traffic between the CPMs 212 and EPMs 214 can be controlled by the switches or routers 210.

The CPMs 212 and EPMs 214 typically drive a type of alarm or light in the field for notification of an event or danger. The lamps are connected to the CPMs 212 or EPMs 214 through the I/O modules. For example, logic in the CPMs 212 and EPMs 214 could detect that the temperature inside a room exceeds a specific value and flash the lamp.

Generally, ControlEdge systems, like the system 200, include one central controller (e.g., the primary CPM 212 or the secondary CPM 212), several expanded controllers (e.g., the EPMs 214), and many I/O modules (e.g., the I/O modules 216). Large-scale ControlEdge systems can include more expanded controllers and I/O modules than are shown in FIG. 2.

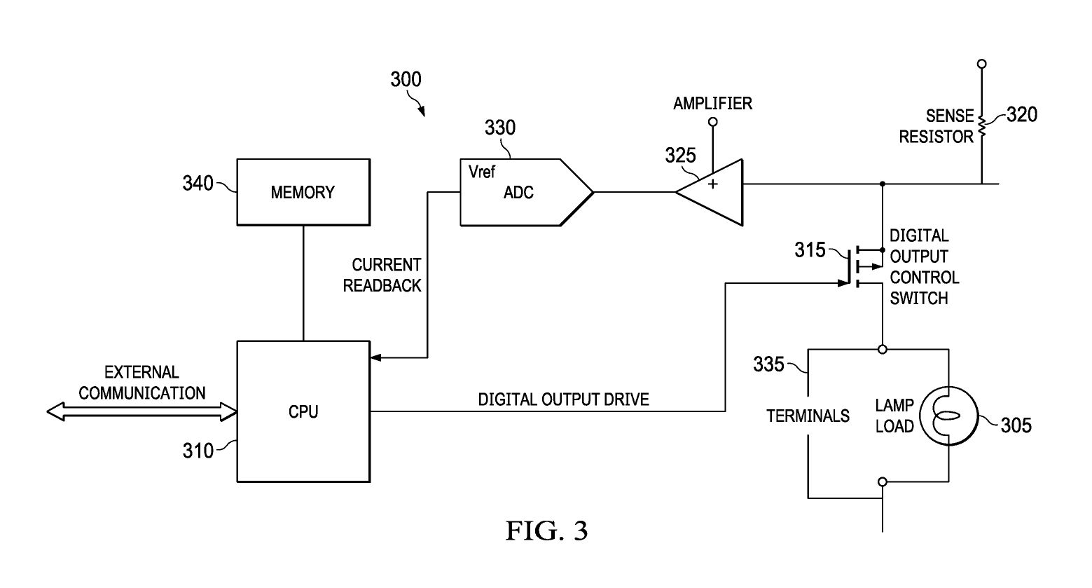

FIG. 3 illustrates a block diagram for a hardware scheme for the digital output module 300 with enhanced support for lamp load according to this disclosure. The embodiment of the digital output module 300 illustrated in FIG. 3 is for illustration only. FIG. 3 does not limit the scope of this disclosure to any particular embodiment.

The digital output module 300 regulates output to the lamp load 305 to avoid high inrush currents. The digital output module 300 is connected to a lamp load 305, a CPU 310, a digital output control switch 315, a sense resistor 320, an amplifier 325, a voltage reference (Vref) analog to digital converter (ADC) 330, terminals 335, and a memory 340.

The lamp load 305 is a load of a lamp, such as an incandescent light bulb, used to indicate a condition of system 100. The lamp load 305 does not have a fixed resistance, but has a cold resistance that is very low. Voltage to the lamp load 305 causes the lamp to glow and heat up. When the lamp is glowing, the resistance of the lamp load 305 is increased causing the current load to drop. The lamp load 305 has an increasing resistance over time until a steady state is reached. When a voltage is applied to the lamp load originally, the resistance is at a lowest point creating a significant inrush current. As the resistance increases, the current settles to a level manageable to maintain the lamp in an active state.

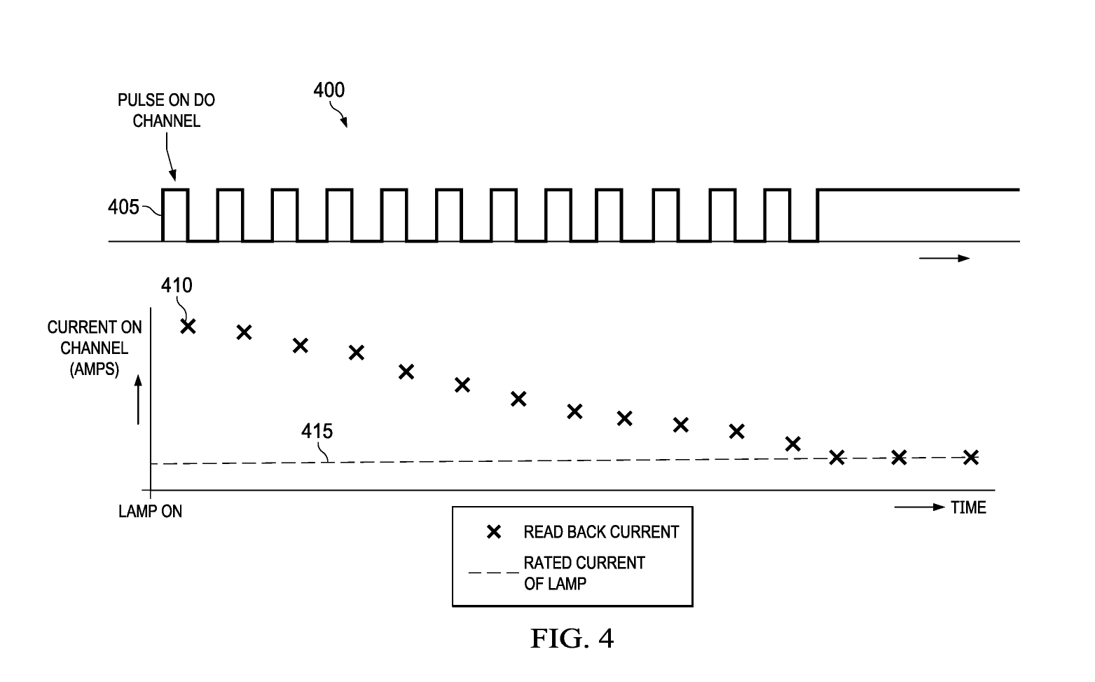

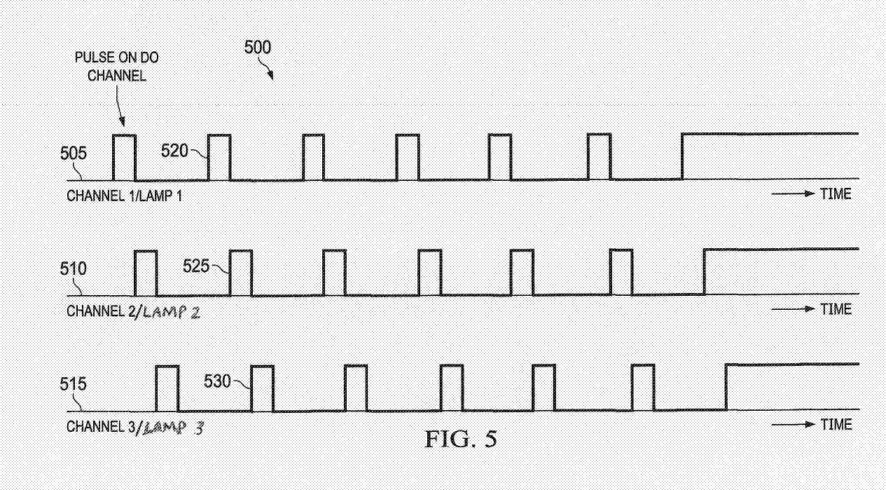

The CPU 310 is the prime interface with the PLC controller or CPMs 212. The CPU 310 monitors the voltage input through a current readback. The CPU 310 controls the digital output control switch 315 through a digital output drive. The CPU 310 communicates externally with the CPMs 212 and the EPMs 214. The CPU 310 drives the digital output. The I/O module 216 can transmit or receive commands to the digital output module 300 through the CPU 310 as shown with the external communication link. The CPU 310 can control the digital output module 300 to drive different voltages. The CPU 310 could store the current value of the lamp load 305 in the memory 340 or report back diagnostics to the PLC controller, CPMs 212, or EPMs 214. The CPU 310 also performs the lamp load algorithm, discussed more in regards to FIGS. 4 and 5. The CPU 310 and the digital output module 300 can operate a plurality of lamp loads 305.

The digital output control switch 315 provides an input path for an applied voltage to the lamp load 305. The digital output control switch 315 is controlled by the CPU 310 to complete or open the circuit with the lamp load 305. The digital output control switch 315 is structured with various currents that can be driven to the lamp load 305. The digital output control switch 315 is the main component controlling the output to the lamp load 305.

The sense resistor 320 provides a low resistance for the current read back loop and measures the current drawn by the lamp load. The resistance of the sense resistor 320 is negligible for affecting the lamp load, but enough to get a reading from the input voltage. The sense resistor 320 is similar to a shunt resistor, which function is to develop a current that is directly proportional to the free current that is flowing in the circuit to the lamp load.

The amplifier 325 amplifies the current level for the current read back loop that is sensed by the sense resistor 320. The sense resistor 320 provides a small value in order to not cause issues related to driving high current loads. The current value needs to be amplified for the Vref ADC 330 to be able to read it.

The Vref ADC 330 converts the voltage reference from analog to digital in order to be read by the CPU 310. The terminals 335 connect to the I/O modules 216.

FIG. 4 illustrates a lamp load algorithm 400 for one channel according to this disclosure. The embodiment of the lamp load algorithm 400 illustrated in FIG. 4 is for illustration only. FIG. 4 does not limit the scope of this disclosure to any particular embodiment.

When an ‘on command’ is received by the PLC controller, the CPU 310 will pulse to the output to the lamp load. The digital output module is configured with the information that this specific output is a lamp load. Based on this configuration, the CPU 310 would pulse the voltage 405 to the lamp and read back the current 410.

The CPU 310 controls the digital output control switch 315 according to the lamp load algorithm 400 to pulse the voltage 405 at a corresponding current 410. As discussed earlier, the initial resistance of the lamp load 305 is much lower than the resistance of the lamp load 305 at the rated current 415. In order to reduce the current load on the controller, the CPU 310 pulses the voltage 405 until the current 410 reaches the rated current 415 for the lamp load. The CPU 310 then leaves the digital output control switch 315 open until the alarm or purpose of the lamp has been addressed.

Eventually the current stabilizes at the rated current 415 of the lamp. Once he current stabilizes, the digital output of the voltage 405 remains on until the condition for the lamp is ended or removed.

FIG. 5 illustrates a multiple lamp loads handling 500 according to this disclosure. The embodiment of the multiple lamp loads handling 500 illustrated in FIG. 5 is for illustration only. FIG. 5 does not limit the scope of this disclosure to any particular embodiment.

The multiple lamp loads handling 500 illustrated in FIG. 5 includes a first channel 505, a second channel 510, and a third channel 515. The pulses 520 on the first channel 505, the pulses 525 on the second channel, and the pulses 530 on the third channel are cycled in order that the currents do not add up until all the lamp loads reach stabilization. In other words, pulses 525 and 530 are differently offset from the pulses 520.

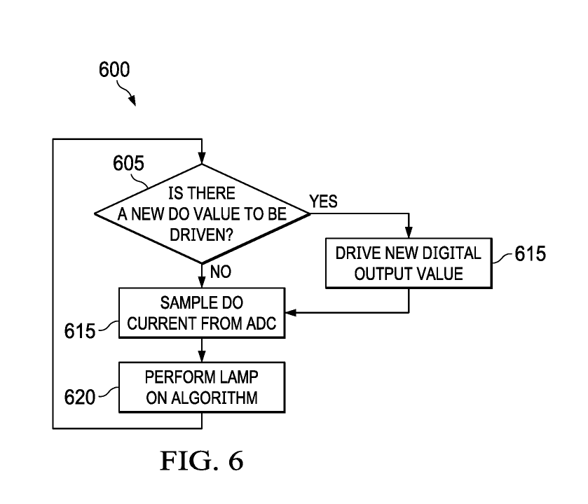

FIG. 6 illustrates an example process 600 for automatic handling of lamp load on a digital output channel according to this disclosure. The embodiment of the process 600 illustrated in FIG. 6 is for illustration only. FIG. 6 does not limit the scope of this disclosure to any particular embodiment.

The CPU 310 performs a continuous loop of digital output handling in process 600. In operation 605, the CPU 310 determines whether a new digital output value is to be driven. A digital output value can be driven to turn on a lamp based on corresponding indication. For example, when an alarm indication is detected, a lamp to indicate the alarm is turned on.

In operation 610, the CPU 310 can drive a new digital value for a lamp load. The new digital value initiates a lamp that was previously not active. This is useful in cases where many lamps are simultaneously activated.

In operation 615, the CPU 310 samples a digital output current from the Vref ADC 330. A sense resistor 320 is placed before the digital output control switch 315 in order to monitor a current applied to the lamp load. The voltage output by the sense resistor is small in order to minimize the effects of high current load conditions of the lamp load. The current is amplified by the amplifier 325 in order to output a current high enough to be input to the ADC 330. The ADC converts the current from an analog state to a digital state for read back in the CPU 310.

In operation 620, the CPU 310 performs a lamp on algorithm. The lamp on algorithm controls the digital output control switch to pulse the current through the lamp load 305. These pulses reduce the amount of time that the digital output module 300 experiences high current levels. In the case of multiple lamp loads initiating simultaneously, the CPU 310 can control one or more digital output switches to cycle the pulses to each of the lamp loads 305.

Digital output modules 300 can drive loads under two constraints, which are (1) a maximum current that can be driven on each output channel in a steady state and (2) a maximum inrush current that the module support for a transient period.

As indicated in FIG. 4, it takes much longer to reach the steady state due to the delay in the element getting heated up in case of lamp loads. This period is much longer than the period supported for inrush current. Since the cold resistance of the lamp load is very low, the lamp can end up drawing current higher than the specified channel limit and could result in a shutdown of the channel output.

Inrush current can be detected by the input/output (10) module. The channels are configured as lamp loads and downloaded to the system. The 10 module can run an algorithm using readback current and channel configuration to control and sequence the lamp load current.

It may be advantageous to set forth definitions of certain words and phrases used throughout this patent document. The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. An industrial control system, comprising:
a digital output channel of a programmable logic controller further configured as a lamp load operable as a status indicator light within the industrial control system;
a digital output control switch configured to open and close a circuit to the lamp load;
one or more processors operably connected to the digital output control switch and the digital output channel, the one or more processors configured to:
receive a readback of a current value applied to the lamp load attached to the digital output channel;
control the digital output control switch to pulse a current to the lamp load based on the readback current value, wherein the current pulse is limited to not cause an overload on the programmable logic controller and the current pulse further heats the lamp to increase the resistance of the lamp load;
determine when the readback current value is equal to a rated current value of the lamp load; and
control the digital output control switch to maintain the current to the lamp load when the readback current value is equal to the rated current value, wherein the current pulses stop when the current is maintained.

2. The industrial control system, of claim 1, further comprising:
a sense resistor located before the digital output control switch and configured to develop a sense voltage that is directly proportional to a current flowing to the lamp load.

3. The industrial control system, of claim 2, further comprising:
an amplifier located in parallel to the digital output control switch after the sense resistor and configured to amplify the sense voltage developed from the sense resistor.

4. The industrial control system, of claim 3, further comprising:
an analog to digital converter located after the amplifier and configured to:
convert the amplified sense current from an analog state to a digital state; and
output the digital state sense current to the one or more processors.

5-7. (canceled)

8. A method for an industrial control system, comprising:
configuring a digital output channel of a programmable logic controller to include a lamp load configured as a status indicator light within the industrial control system;
receiving, at a processor, a readback of a current value applied to the lamp load attached to the digital output channel; and
controlling a digital output control switch to pulse a current to the lamp load based on the readback current value, wherein the digital output control switch opens and closes a circuit to the lamp load, wherein the current pulse is limited to not cause an overload on the programmable logic controller and the current pulse heats the lamp to increase the resistance of the lamp load
determining when the readback current value is equal to a rated current value of the lamp load; and
controlling the digital output control switch to maintain the current to the lamp load when the readback current value is equal to the rated current value, wherein the current pulses stop when the current is maintained.

9. The method of claim 8, further comprising:
developing a sense voltage that is directly proportional to a current flowing to the lamp load using a sense resistor located before the digital output control switch.

10. The method of claim 9, further comprising:
amplifying the sense voltage developed from the sense resistor using an amplifier located in parallel to the digital output control switch after the sense resistor.

11. The method of claim 10, further comprising:
converting the amplified sense voltage from an analog state to a digital state using an analog to digital converter located after the amplifier; and
outputting the digital state sense current to the processor from the analog to digital converter.

12-14. (canceled)

15. A non-transitory machine-readable medium encoded with executable instructions that, when executed, cause one or more processors to:
configure a digital output channel of a programmable logic control to include a lamp load configured as a status indicator light within an industrial control system;
receive a readback of a current value applied to the lamp load attached to a digital output channel; and
control a digital output control switch to pulse a current to the lamp load based on the readback current value, wherein the digital output control switch opens and closes a circuit to the lamp load, wherein the current pulse is limited to not cause an overload on the programmable logic controller and the current pulse heats the lamp to increase the resistance of the lamp load,
determine when the readback current value is equal to a rated current value of the lamp load; and
control the digital output control switch to maintain the current to the lamp load when the readback current value is equal to the rated current value, wherein the current pulses stop when the current is maintained.

16. The non-transitory machine-readable medium of claim 15, wherein the executable instructions further cause the one or more processors to:
develop a sense current that is directly proportional to a current flowing to the lamp load using a sense resistor located before the digital output control switch; and
amplify the sense current developed from the sense resistor using an amplifier located in parallel to the digital output control switch after the sense resistor.

17. The non-transitory machine-readable medium of claim 16, wherein the executable instructions further cause the one or more processors to:
convert the amplified sense current from an analog state to a digital state using an analog to digital converter located after the amplifier; and
output the digital state sense current to the one or more processors from the analog to digital converter.

18-20. (canceled)
